(19) United States
(12) Patent Application Publication
(10) Pub. No.: US 2017/0285888 A1
(43) Pub. Date: Oct. 5, 2017

(54) SMART PAD CALL UP SYSTEM

(71) Applicant: JEFF SCHMIDT, DAVIS, CA (US)

(72) Inventor: JEFF SCHMIDT, DAVIS, CA (US)

(21) Appl. No.: 15/090,627

(22) Filed: Apr. 5, 2016

(51) Int. Cl. G06F 3/0482; G06Q 30/06; G06F 3/0354; G06F 3/16; G06F 3/023

(52) U.S. Cl. CPC G06F 3/0482; G06F 3/167; G06F 3/023; G06F 3/03545; G06Q 30/0633

(57) ABSTRACT

A smart pad call up system enables connection of the electronic notepad or any communication device or multiple communication devices of the family members. The smart pad call up system updates every time when an item is placed on the smart pad call up system via handwritten entry with a stylus or keypad. The Smart pad call up system would have a voice command feature so that shopping list items is entered verbally in addition to stylus or keypad entry. This allows access to an updated grocery list to anyone with a communication device.

### FIELD OF THE INVENTION

The present invention is related to a smart pad call up system which enables connection of the electronic notepad with at least one communication device.

### BACKGROUND OF THE INVENTION

Usually, short term memory loss or forgetting things quickly is one of the common problems of a person in today's world. This is not only common in old people but even youngsters or the middle age people are unable to recall from their memory. Moreover, remembering, learning and retaining new information are a few of the most common complaints of elder adults.

In addition to this, their often retain a problem to store and realize the list of the items and more often we also forget carrying the list of the items to be purchased along with us. As well as, sometimes we add items to the list, but a person went for buying items stop's at the store after work, could not make out of these recently added items and they would not be purchased.

Therefore, there remains a need to overcome above mentioned problems and our invention resolve this entire problem.

### SUMMARY OF THE INVENTION

In order to solve the above mentioned problem, the present invention provides a smart pad call-up system enables connection of the electronic notepad on the user's refrigerator or to at least one communication device of a user.

The smart pad call-up system updates every time when an item is placed on the fridge pad via handwritten entry with a stylus or keypad. The Smart pad call-up system would have a voice command feature so that shopping list items are entered verbally in addition to stylus or keypad entry. This allows access to an updated grocery list to anyone in the family with a communication device. The smart pad call-up system is enabled to automatically update/delete items when marked as purchased from in my cart on the user's phone. The app icon on the communication device is enabled to show an updated count of the number of items on the list. Items are added directly to the app via a communication device. Moreover, the smart pad call-up system feature ensures that family members such as children or elderly person are also enabled to add to the family shopping list from home as household items are depleted.

In addition to this, no communication device is required to contribute to the list from home. This allows a user to always have an updated list wherein, the smart pad call up system feature is built into new model refrigerators so that it does not need to be purchased as an add-on item. Also, the shop list app is capable of saving multiple lists such as routine lists which do not have to be regenerated each time. (Ex: ingredients for favorite recipes, weekly recurrent items (history) or special events such as Thanksgiving Dinner, Easter Brunch.) The lists are sorted out by alphabetically, chronologically, or in categories (meat, dairy, produce, etc.) to make shopping more efficient.

Moreover, the lists do not have to be limited to shopping items. Lists for daily chores, to-do lists or home-work could be generated from the smart pad call up system and be shared by all family members in the network. If the user chooses to not to do their own shopping, but still wants to use the smart pad call up system for its convenience, there would be an option that the user could upload the shopping list to a grocery home delivery service such as Amazon Fresh, InstaCart, or PeaPod.

Also, the smart pad call up system is designed to encourage use of family members of all ages and allows for home delivery service, which makes shopping more efficient by categorizing items for purchase.

### BRIEF DESCRIPTION OF THE DRAWINGS

FIG. 1 illustrates the schematic view of the given invention according to an embodiment of the invention.

### DETAIL DESCRIPTION OF THE DRAWINGS

Reference will now be made in detail to the exemplary embodiment(s) of the invention, examples of which are illustrated in the accompanying drawings. Whenever possible, the same reference numerals will be used throughout the drawings to refer to the same or like parts.

The present invention relates generally to a user friendly application which is designed to connect a smart pad call up system 100 on the user's refrigerator, anywhere in user's house, to the user's smart phone or multiple smart phones of family members.

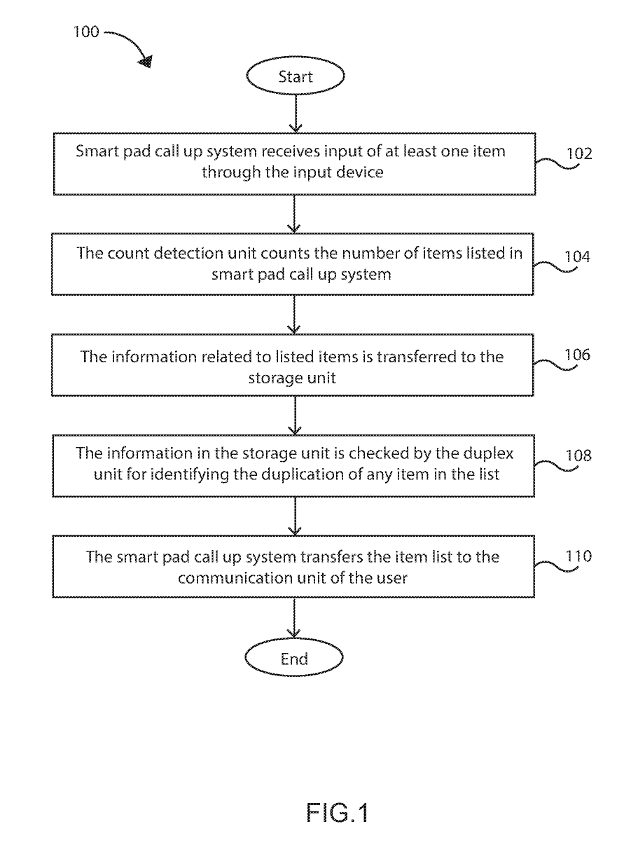

Step. 102 of FIG. 1 illustrates a smart pad call up system which enables receiving input of at least one item through the input device, wherein the smart pad call up system is at least one of electronic note pad, a (smart) phone or else any communication device which enables duplex communication which is able to send and receive information simultaneously. A smart pad call up system is a computer program designed to replace paper laboratory notebooks from electronic tabs, wherein the electronic note pad are easier to search upon, simplify data copying and backups, support collaboration amongst many users. The smart pad call up system is enabled to automatically update/delete items when marked as purchased from in my cart on the user's phone or any smart device having the application installed for the smart pad call up system. Herein the input device used is at least one of either a stylus or a keypad to enter the item list manually by the user and is also portable to accept voice command that is it is capable operating for verbal commands too, a smart pad call up system is associated with a smart device through an application wherein the application is capable of storing the items list and need not to be regenerated every time after and before the deletion or updating of any item.

Step. 104 of FIG. 1 illustrates a count detection unit wherein the count detection unit enables the count of items in the item list which is need to be purchased from the market or any general store wherein, show an updated count of the number of items on the list. Herein, the smart pad call up system also enables the Items list to be added directly to the app via any communication device. Also, the lists produced are sorted alphabetically, chronologically, or in categories (meat, dairy, produce, etc.) to make shopping more efficient. Moreover, the list produced does not have to be limited to shopping items. Lists for daily chores, to-do lists or home-work is generated from the smart pad call up system and be shared by all family members in the network. In the present unit to make user's work more easy check-box is provided adjacent to each item providing the count of the item, making the work of the user easy to access, by marking it checked, providing the information to both the user and to the buyer by telling them that the item is marked in the list of purchase and to the buyer giving him the information of the items to be purchased along with the information of the items newly added to the list with the information of the person adding the item to list.

Step. 106 of FIG. 1 illustrates the storage unit wherein the information related to listed items is transferred to the storage unit is enabled to store information of the items to be purchased or to be deleted from the present item list. Also, the storage unit keep a track of the item newly added to the list and have to be in the list for urgent. The present invention is designed to encourage users as it is easy to operate wherein, the storage unit is enabled to reset any time by anyone to provide a new and fresh item list updates. This unit stores sufficient amount of memory storage to provide easy storage of the items without any deletion of the items to update new items. Also, the list will have a check box next each item on the list. When the check box is checked off the item on the list it will be removed from the storage unit.

Step. 108 of FIG. 1 illustrates the duplication unit wherein, the information in the storage unit is checked by the duplex unit for identifying the duplication of any item in the list. The duplication unit also eliminates incomplete shopping excursions.

Step. 110 of FIG. 1 illustrates the communication unit wherein the communication unit defines the smart pad call up system transferring the item list to the communication device or any smart device of the user.

In the preferred embodiment, user for the smart pad call up system is provided with a electronic pad or any duplex communication device capable of taking verbal or manual input of the item list from the user wherein the user is allowed to write their shopping list with the stylus or the keypad on the smart pad call up system. This smart pad call up system has voice detection capability where the system detects the voice of the user, by use of voice sensors wherein, anything entered in the smart pad call up system is sent to the application installed in user smart device. The application will detect the writing or voice that is entered by the user and it will list to the user's smart device to provide a list of the item to be purchased by him while coming or going out from or to any place respectively. The list will have a check box next each item on the list. When the check box is checked off the item on the list it will be removed.

In other embodiment, user for smart pad call up system makes the entry of the item list on the smart pad call up system via stylus, keypad or via user's voice as the system is capable of taking verbal input also and prepares a list of the item to be purchased or bought from the market wherein this list is then been sent to any particular shop or to the particular shopkeeper with enabled smart pad call up system app on his/her communication device. The present invention also have the option of uploading their shopping list to grocery home delivery service such as Amazon fresh, lnstacart, or Peapod. If, the user chooses not to do their own shopping, but still wants to use the smart pad call up system for its convenience, there would be an option that the user could upload the shopping list to a grocery home delivery service such as Amazon Fresh, InstaCart, or PeaPod and will get the item in the list delivered at his/her place.

In another embodiment, the scope of particular invention of smart pad call up system is not only limited for shopping and buying good/item(s).This invention provides its use for recalling items or any requirement for day today life's or for day today's routine of a person(s). The smart pad call up system is also enabled to be used by a person of any age even kids to keep a track record of the things to be needed for their schools, projects, home work(s), it is also enabled to be used by youngsters for keeping a track record of their daily routines or any special occasion which very often to forget as well as by any middle aged or old people to keep a track record of their medicines, checkups, routines or anything which is likely more often to forget.

What is claimed is:

1. A smart pad call up system enabled to communicate with at least one communication device, comprising:
an input unit, for entering detail of at least one item, wherein the input unit enables data entry of the at least one item either via manually or via voice in the smart pad call up system;
an item list unit enabled to receive input from the input unit, wherein the item list unit enables automatic or manual update and deletion of the item data every time; and
a duplex identification unit, wherein the duplex identification unit identifies the duplication of any item in a storage unit and enables communication to the smart pad call up system and is further enabled to wirelessly transmit the item list to the communication device.

2. The smart pad call up system according to claim 1, wherein the input unit is either a stylus or a keypad or a voice interaction system for manually entering the item details.

3. The smart pad call up system according to claim 1, wherein the item are added directly to the item list unit by the communication device.

4. The smart pad call up system according in claim 1, wherein the smart pad call up system is a portable system.

5. The smart pad call up system according to claim 1, wherein the items in the item list unit are sorted alphabetically, chronologically, or in categories like (meat, dairy, produce, etc.) to make shopping more efficient.

6. The smart pad call up system according to claim 1, wherein the smart pad call up system is an in-built feature of at least one of a refrigerator, a microwave, television, window air conditioner but is not limited to only these.

7. The smart pad call up system according to claim 1, wherein the smart pad call up system is fixed or removable-ly attached with refrigerators or any other device.

8. The smart pad call up system according to claim 1, wherein the smart pad call up system is enabled to automatically eliminate incomplete shopping excursions.

9. A method enabling operation of a smart pad call up system establishing communication with at least one communication device, the method comprising:
inputting data entry of at least one item either via manually or via voice in the smart pad call up system;
receiving input from the input unit and updating, manually or automatically, item data every time;
identifying duplication of stored data in a storage unit and enables communication to the smart pad call up system and is further enabled to wirelessly transmit the item list to the communication device.

10. The method enabling operation of a smart pad call up system of claim 9, wherein the input unit is either a stylus or a keypad or a voice interaction system for manually entering the item details.

11. The method enabling operation of a smart pad call up system of claim 9, wherein the item are added directly to the item list unit by the communication device.

12. The method enabling operation of a smart pad call up system of claim 9, wherein the smart pad call up system is a portable system.

13. The method enabling operation of a smart pad call up system of claim 9, wherein the items in the item list unit is sorted alphabetically, chronologically, or in categories like (meat, dairy, produce, etc.) to make shopping more efficient.

14. The method enabling operation of a smart pad call up system of claim 9, wherein the smart pad call up system is an in-built feature of at least one of a refrigerator, a microwave, television, window air conditioner but is not limited to only these.

15. The method enabling operation of a smart pad call up system of claim 9, wherein the smart pad call up system is fixed or removable-ly attached with refrigerators or any other device.

16. The method enabling operation of a smart pad call up system of claim 9, wherein the smart pad call up system is enabled to automatically eliminate incomplete shopping excursions.
